(19) United States
(12) Patent Application Publication
(10) Pub. No.: US 2008/0305832 A1
(43) Pub. Date: Dec. 11, 2008

(54) SHARING PROFILE MODE

(75) Inventor: Itai Greenberg, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/759,302

(22) Filed: Jun. 7, 2007

(51) Int. Cl. H04B 1/38

(52) U.S. Cl. 455/557

(57) ABSTRACT

The claimed subject matter provides a system and/or a method that facilitates data transmission related to a mobile device utilizing a sharing profile. An interface component can receive a portion of data associated with a mobile device. A distribution component can transmit the portion of data to an entity based at least in part upon a sharing profile that defines the entity and a respective transmission mode.

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In light of such technological advances, an immense amount of data can be generated and/or associated with computer hardware, software, and networking. With the current trend of being connected and/or available for various communications with electronic devices such as mobile devices, personal computers, etc., there can be generous amount of data associated therewith. Specifically, today's mobile devices (e.g., mobile phones, personal digital assistants (PDAs), any suitable mobile equipment for communication, etc.) can generate an overwhelming amount of data based on these mobile devices having the capability to be full-service mechanisms (e.g., word processing, web browsing, electronic mail (email), accounting, camera functionality, video camera functionality, audio recording functionality, media playback functionality, etc.).

The data generated, captured, and/or associated with electronic devices are typically shared and/or transmitted to various entities (e.g., users, machines, devices, etc.). However, sharing data with electronic devices can include meticulous and redundant steps and/or procedures which can hinder or even, dissuade a user from data sharing. For instance, a user must explicitly specify the media content (e.g., pictures, songs, video, location, personal details, contact information, files, etc.), a technique and/or transmission mode, and a target audience for each portion of data that is to be shared. Thus, sharing data to more than one individual entails repeating the sharing procedure for each individual and/or target. Thus, convention data sharing techniques and/or mechanism are repetitive and inefficient.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate communicating data with a mobile device utilizing a sharing profile. A distribution component can employ a sharing profile to communicate a portion of data identified, selected, and/or captured by a mobile device. The sharing profile can define a target entity and a transmission mode. In other words, a portion of data can be identified and transmitted based upon the definitions associated with an active sharing profile. For example, a user can create a sharing profile with at least one target entity defined and a respective transmission mode. It is to be appreciated that a profile can relate to how a device notifies a user of incoming/outgoing data transmissions and/or messages. Upon activation and/or initiation of the sharing profile, any data collected, identified, selected, and/or captured by the mobile device can be automatically distributed based upon the sharing profile. Thus, data can be communicated to the defined target entity or entities via the defined transmission mode. Moreover, a sharing profile can include more than one share mode and/or technology, expiration, etc.

The sharing profile can include various characteristics in addition to defining a target entity and a transmission mode. The distribution component can utilize a settings component that can populate a characteristic/detail associated with the sharing profile based upon a portion of profile data. The sharing profile data can define additional characteristics such as, but not limited to, a time delay for transmission, entity data, an automatic transmission on a schedule, notification settings, transmission settings, publication configuration, security, frequency of sharing/distributing data, proximity transmission settings, online versus offline, size of content, personalization information (e.g., background, priority, etc.) and/or any suitable detail related to transmitting data to an entity within a transmission mode. The distribution component can further include a manager component that facilitates managing a plurality of sharing profiles associated with a mobile device. For example, the manager component can provide the addition, deletion, editing, etc. of a sharing profile. Moreover, the manager component can provide an active mode or a passive mode in relation to initiating a sharing profile for distributing data. In other aspects of the claimed subject matter, methods are provided that facilitate distributing data from a mobile device to various entities utilizing a sharing profile. Moreover, the manager component can be set by the user of the device or by a system administrator through provisioning.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates communicating data with a mobile device utilizing a sharing profile.

FIG. 2 illustrates a block diagram of an exemplary system that facilitates managing a sharing profile that specifies data transmissions for a mobile device.

FIG. 3 illustrates a block diagram of an exemplary system that facilitates transmitting selected data to a plurality of entities with respective distinct characteristics.

FIG. 4 illustrates a block diagram of an exemplary system that facilitates distributing data from a mobile device to various entities utilizing a sharing profile.

FIG. 5 illustrates a block diagram of exemplary system that facilitates utilizing a sharing profile to identify an entity and a transmission technique to distribute data with a mobile device.

FIG. 6 illustrates an exemplary methodology that facilitates employing a sharing profile for data communication with a mobile device.

FIG. 7 illustrates an exemplary methodology for transmitting selected data to a plurality of entities with respective distinct characteristics.

FIG. 8 illustrates an exemplary methodology that facilitates communicating data with a mobile device utilizing a sharing profile.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “sharing profile,” “store,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

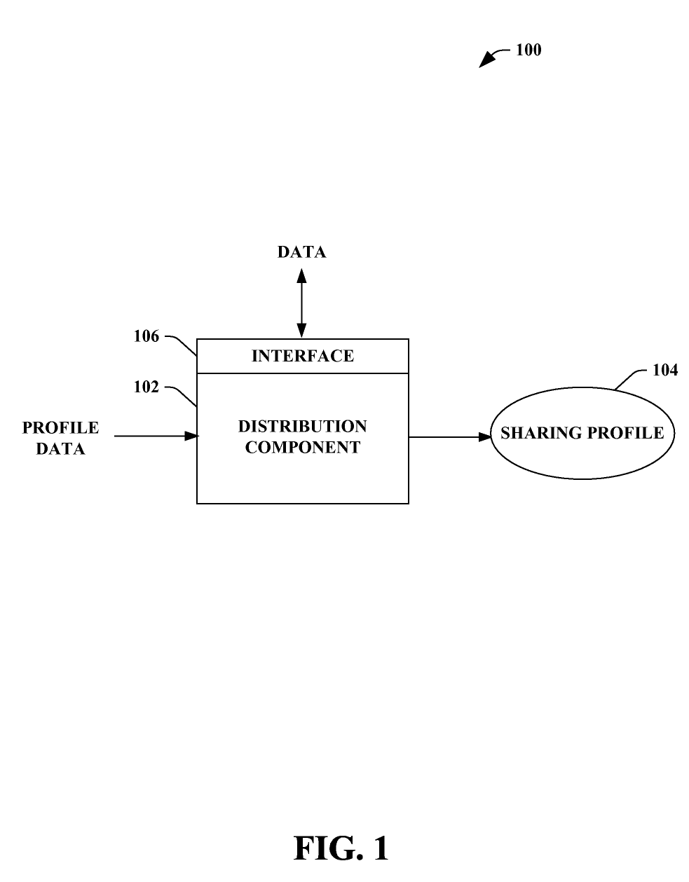

Now turning to the figures, FIG. 1 illustrates a system 100 that facilitates communicating data with a mobile device utilizing a sharing profile. The system 100 can include a distribution component 102 that can receive a portion of data via an interface component 106 in order to transmit the portion of data based at least in part upon a sharing profile 104. The distribute component 102 can employ the sharing profile 104 to define a transmission mode and a target entity to share and/or distribute data. In other words, the distribution component 102 can ensure received data is distributed with the sharing profile 104, wherein the sharing profile 104 can identify at least one target entity and a transmission mode and/or technique in which to transmit such data. By utilizing the sharing profile 104, sharing data to various entities with numerous transmission modes can be simplified. It is to be appreciated that the distribution component 102 can generate the sharing profile 104 based at least in part upon settings, configurations, options, etc. associated with profile data (discussed in more detail below). It is also to be appreciated that a profile can relate to how a device notifies a user of incoming/outgoing data transmissions and/or messages.

For example, the sharing profile 104 can include a list of entities and a transmission mode to transfer data, in which a user can activate and/or utilize the sharing profile with a mobile device. An entity can be, but is not limited to, a user, a machine, a device, a portable device, a recipient, a web server, an online community, a peer-to-peer network, a network, an online environment, a website, an email server, a laptop, a personal computer, a cellular phone, a mobile communications device, a cellular device, a portable digital assistant (PDA), a hand-held, a smartphone, a portable media device, a gaming device, a blog, an online forum, a data store, a display device, a television, a plasma display, a liquid crystal display (LCD), a monitor, etc. Furthermore, it is to be appreciated that the transmission mode can be most any suitable mode and/or technique (e.g., website, application, environment, etc.) such as, but not limited to, email, multi-media service (MMS), video, text message, audio, image, Bluetooth, wireless, Wireless Fidelity (Wi-Fi), Infra Red, posting to an online environment, publication to the Internet, instant message, voicemail, a post to a website, near field communications (NFC), instant messaging (e.g., many different service providers), etc.

Specifically, a mobile device can employ the sharing profile 104 which can allow the definition of a preferred transmission mode and a preferred target to share content/data with. Once a sharing profile has been created (discussed in more detail below), any media/data selected on the mobile device can be automatically shared based on the preconfigured sharing profile settings. It is to be appreciated that the sharing profile 104 can enable the sharing experience to be transparent and seamless to the user. As discussed, the distribution component 102 can enable automatic data sharing based upon the sharing profile 104 with any suitable mobile device. It is to be appreciated that the distribution component 102 can implement the sharing profile 104 with a mobile device as well as any suitable device that can store data, such as, but not limited to, media content, audio, video, data files, image, etc.

For instance, a user can create a sharing profile “Julie's mobile” on a mobile device, wherein such profile can define settings related to a target identity (e.g., Julie's mobile phone) and a transmission mode (e.g., MMS). Upon activation of the sharing profile, data identified/selected can be automatically transmitted based upon the settings corresponding to the sharing profile (e.g., data sent to Julie via MMS). In another example, a profile can be saved on Julie's contact, so that when the user chooses to send to Julie, it does not need to specify how. This is especially valuable if Julie is part of a group that the user is sending contact to. It is to be appreciated that most any suitable entities can be associated and/or linked to a sharing profile and the above example is for illustration purposes only. Furthermore, a user may define more than one sharing profile that can be persistent with a mobile device and/or most any suitable electronic device that can capture and/or transmit data (e.g., laptop, machine, PDA, hand-held, cellular device, etc.). For instance, a first sharing profile can correspond to a spouse device via streaming video, while a second sharing profile can correspond to a listing of friend's devices via an online community website (e.g., posting to a website). Moreover, a third sharing profile can be with a parent via email. It is to be appreciated that any of the first, second, or third sharing profiles can be activated and/or initiated at any given time. In another example, the sharing profile can share a location with friends via a website and/or web service.

In addition, the system 100 can include any suitable and/or necessary interface component 106 (herein referred to as “interface 106”), which provides various adapters, connectors, channels, communication paths, etc. to integrate the distribution component 102 into virtually any operating and/or database system(s) and/or with one another. In addition, the interface component 106 can provide various adapters, connectors, channels, communication paths, etc., that provide for interaction with the distribution component 102, the sharing profile 104, profile data, received data, and any other device and/or component associated with the system 100.

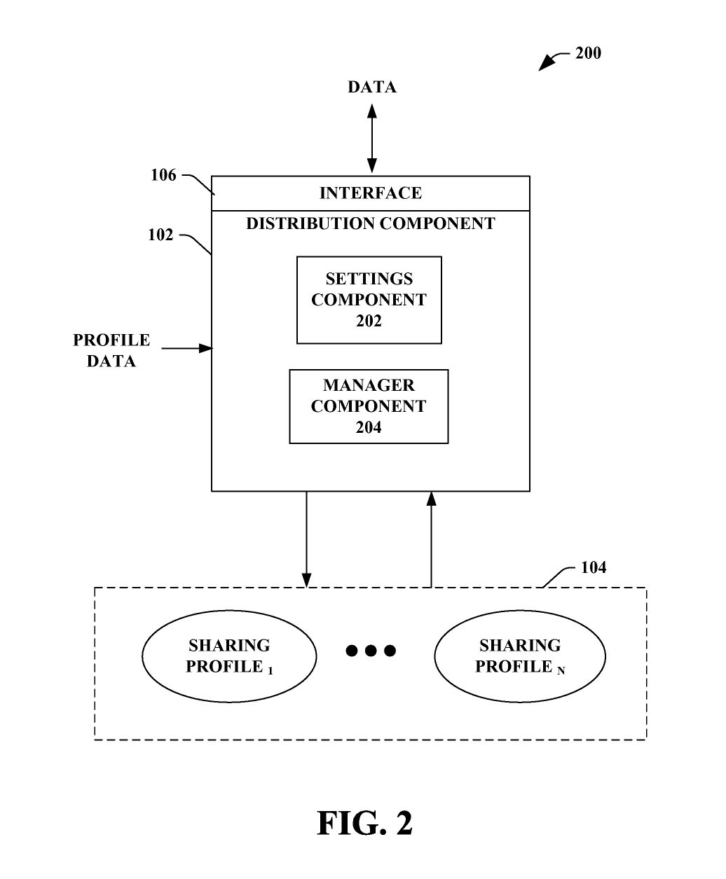

FIG. 2 illustrates a system 200 that facilitates managing a sharing profile that specifies data transmissions for a mobile device. The system 200 can include the distribution component 102 that can create and employ the sharing profile 104 in order to distribute data to particular entities in a specific transmission mode. For instance, a user can generate a sharing profile that can be defined to include at least one target entity (e.g., the entity in which to share data and/or the entity that receives data) and a transmission technique/mode (e.g., the manner in which to transmit and/or share the data), wherein such definitions can be associated with profile data (e.g., pre-defined, default, user-defined, etc.). The distribution component 102 can transmit data to a target in a particular manner based at least in part upon the sharing profile 104 and settings defined therewith (e.g., profile data). Moreover, the distribution component 104 can utilize most any suitable number of sharing profiles such as sharing profile I to sharing profile N, where N is a positive integer.

The distribution component 102 can include a settings component 202 that can define specifics related to at least one sharing profile 104 based at least in part upon profile data. In one example, the settings component 202 can include default settings related to sharing profiles. In another example, the settings component 202 can allow sharing profile settings to be user-defined. It is to be appreciated that the settings component 202 can provide at least one characteristic/detail of a sharing profile to be defined. For instance, the sharing profile 104 can include any suitable setting and/or configuration data (e.g., profile data) such as, but not limited to, target entity, (e.g., user, machine, device, website, online environment, online community, etc.), transmission mode (e.g., wireless, MMS, text message, over the air, active sync (e.g., cradle mode, etc.), SMS, video, audio, image, etc.), a time delay for transmission (e.g., transmit upon data selection (e.g., one can select sharing profile prior or after selecting the sharing media, etc.), an automatic transmission on a schedule, transmit with time delay upon data selection, etc.), entity data (e.g., priority, target address, device associated with entity, entity name, entity location, entity preferences, etc.), notification settings (e.g., transmission success receipt, read receipt to target entity, publication notification, notification technique/mode, etc.), transmission settings (e.g., maximum/minimum data transmission limits, time stamp, transmission size, date, etc.), publication configuration (e.g., website location/address, entity address, format, layout, resolution of data, data size, etc.), security (e.g., display of target entities, data protection, etc.), frequency of sharing/distributing data, online versus offline, size of content, personalization information (e.g., background, priority, etc.), proximity transmission settings (e.g., distribute according to activated sharing profile within a particular geographic distance, etc.), content additional attributes (e.g., location from a global positioning service (GPS), etc.), and/or any suitable detail related to transmitting data to an entity within a transmission mode.

For example, a sharing profile can be generated in which a listing of entities and a transmission mode can be defined. Additionally, the sharing profile can include a security setting that disables the display of addresses related to the target entities or other relevant security settings. Moreover, the data can be transmitted every thirty minutes, wherein notification/certification of a successful transmission can be received by a sender. The sharing profile can also include a proximity setting that can distribute the data to entities within a geographic proximity (e.g., utilizing tracking techniques associated with global positioning systems (GPS), triangulation techniques, user defined location, etc.). A priority can be further related to entities within a sharing profile in which data can be transmitted to certain entities accordingly.

The system 200 can further include a manager component 204 that can employ management to a plurality of sharing profiles 104. For example, the manager component 204 can allow addition, deletion, editing, creation, etc. of the various sharing profiles associated with a mobile device. In particular, the manager component 204 can employ various settings related to the general implementation of a sharing profile. For example, the manager component 204 can allow a user specified manner for activating a sharing profile such as, but not limited to, an active sharing profile mode, a passive sharing profile mode, and/or any suitable combination. The active sharing mode can allow a sharing profile to be selected, data/content to be selected, such data to be transmitted, and the deactivation of such sharing profile. In contrast, the passive sharing mode can allow data/content to be selected, a sharing profile to be selected, and the transmission of the selected data/content. The manager component 204 can further provide assistance in tracking/monitoring the plurality of sharing profiles associated with a mobile device (e.g., frequency of sharing profile user, number of user profiles, dynamic updates related to data defined in the sharing profile, etc.). Thus, the manager component 204 can allow dynamic and real-time updates to be collected and/or detected in relation to data defined in a sharing profile. For instance, an email address defined in a sharing profile mode may not be accurate and/or up-to-date. The manager component 204 can provide notification to the sharing profile owner and/or provide an automatic update of such data. In another example, the manager component 204 can automatically provide suggestions related to creating new sharing profiles based on monitoring/tracking data transmissions, target entities, etc. which can greatly improve data transmission efficiency. In addition, the manager component 204 can allow sharing profiles to be synchronized to more than one device. For instance, a user can utilize a plurality of devices in which the sharing profiles can be existent and/or consistent throughout (e.g., device A includes up-to-date sharing profiles, device B includes up-to-date sharing profiles, etc.). Moreover, the manager component can be set by the user of the device or by a system administrator through provisioning.

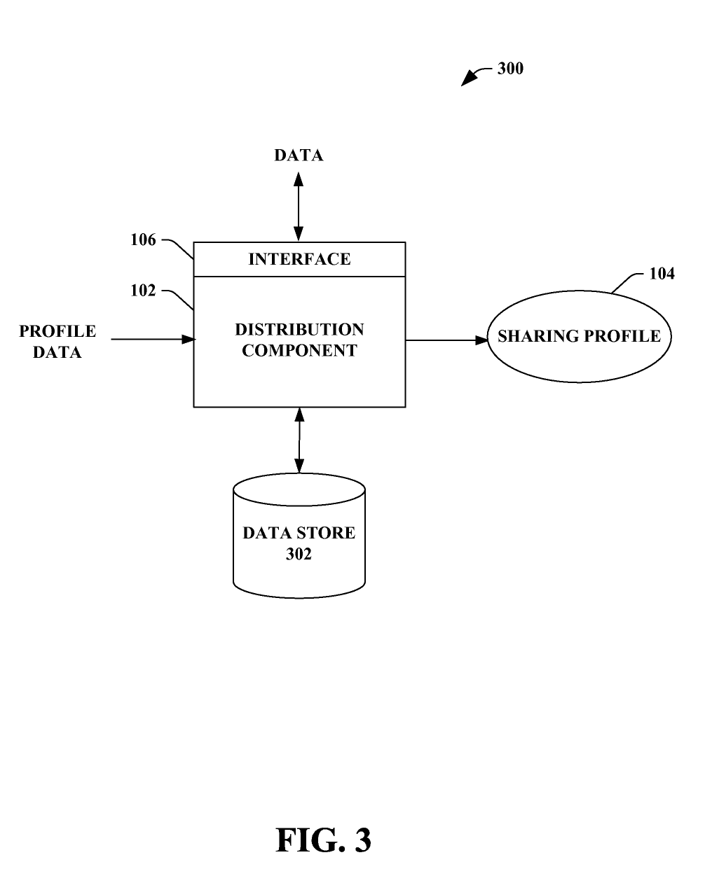

FIG. 3 illustrates a system 300 that facilitates transmitting selected data to a plurality of entities with respective distinct characteristics. The system 300 can include the distribution component 102 that can utilize the sharing profile 104 with definitions (e.g., target entity, transmission mode, profile data, etc.) in order to efficiently transmit data from a mobile device. The distribution component 102 can utilize the sharing profile 104 defined at least in part upon profile data in order to communicate data to at least one entity in a particular transmission mode/technique.

The system 300 can further include a data store 302 that can include any suitable data related to the distribution component 102, the sharing profile 104, profile data, data to be transmitted, transmission modes, etc. For example, the data store 302 can include, but not limited to including, profile data, sharing profile, sharing profile settings, sharing profile options, target entity, transmission mode, a time delay for transmission, an automatic transmission on a schedule, entity data, notification settings, transmission settings, publication configuration, frequency of sharing/distributing data, proximity transmission settings, user-defined settings, user preferences, historic data related to transmissions, user tendencies/preferences, online versus offline, size of content, personalization information (e.g., background, priority, etc.), etc.

It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 302 of the subject systems and methods is intended to comprise, without being limited to, these and any other suitable types of memory. In addition, it is to be appreciated that the data store 302 can be a server, a database, a hard drive, a pen drive, an external hard drive, a portable hard drive, and the like.

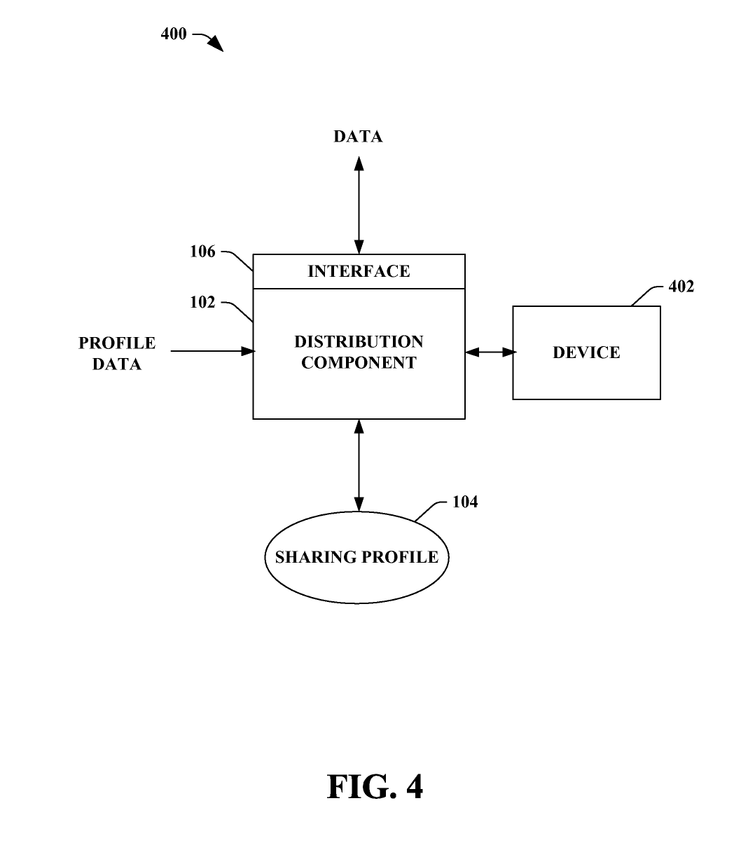

FIG. 4 illustrates a system 400 that facilitates distributing data from a mobile device to various entities utilizing a sharing profile. The system 400 can utilize the distribution component 102 that can employ the sharing profile 104 to distribute data to a particular entity in a specific transmission mode. The distribution component 102 can be utilized with a device 402, wherein the device 402 can transmit data to various entities according to a sharing profile definition (e.g., target entity, transmission mode/technique, profile data, etc.). For example, the device 402 can implement the sharing profile 104, in which data captured and/or identified with the device 402 can be communicated accordingly. It is to be appreciated that the distribution component 102 can be incorporated into the device 402, a stand-alone component (as depicted), and/or any suitable combination thereof.

The sharing profile 104 can define at least one target entity (e.g., an entity to which data is to be transmitted) and a transmission mode/technique (e.g., the manner in which to transmit identified data). The device 402 can enable the identification and/or collection of data, wherein such data can be communicated based at least in part upon the sharing profile 104 and respective definition. As discussed above, the sharing profile 104 can include a variety of characteristics, settings, configurations, details, etc. depicted by profile data. The sharing profile 104 can route data to various entities utilizing specific transmission modes.

For example, a conventional experience with sending data to a user from a mobile device can include numerous steps, procedures, actions, etc. Specifically, selecting the data, selecting or entering the recipient, selecting the method, adding additional data (ex: location), sending. This often needs to be repeated per item or recipient. The following sequence can be a typical and conventional manner in which to capture and transmit data: capture data; enter transmission manner; select transmission mode (e.g., email, etc.); select transmission mode details (e.g., email account, etc.); identify recipient; add recipient; identify additional recipient; add recipient; and send/transmit data. To send an additional portion of data to the recipients, the substantially similar procedure can be applied which can be tedious and redundant. However, employing the distribution component 102 and the sharing profile 104, communicating data via mobile devices is greatly enhanced. For example, a sharing profile mode can be created and defined. Once created, a user can select such sharing profile and capture/identify data, wherein such data can be automatically transmitted to the defined target entity with the defined transmission mode. Once the sharing profile is activated, identified/collected/captured data can be continuously and automatically communicated based at least in part upon the sharing profile.

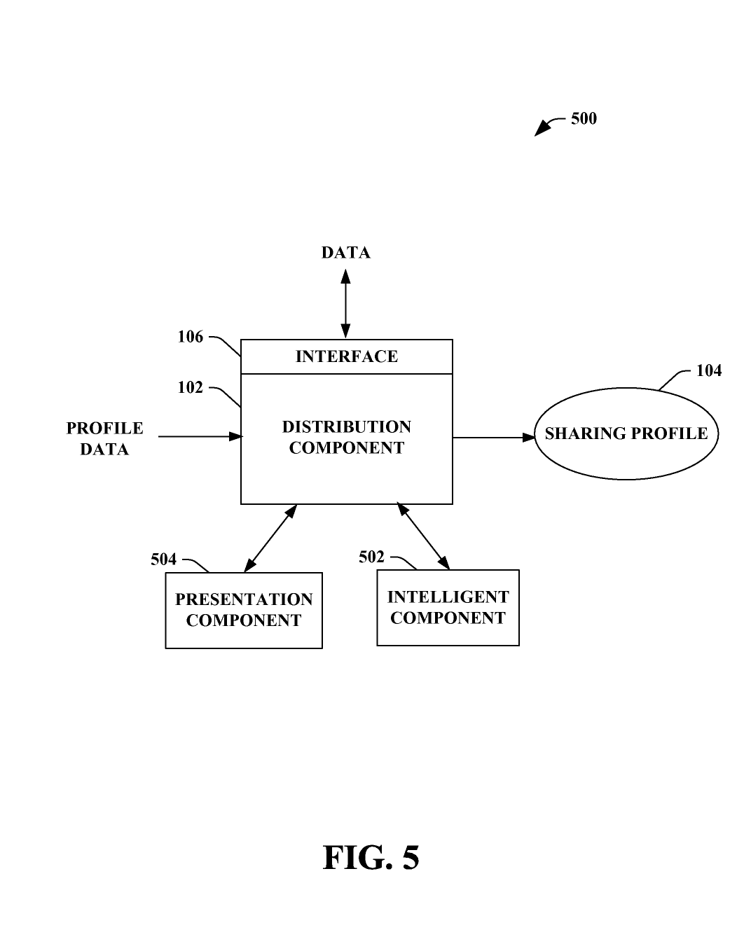

FIG. 5 illustrates a system 500 that employs intelligence to facilitate utilizing a sharing profile to identify an entity and a transmission technique to distribute data with a mobile device. The system 500 can include the distribution component 102, the sharing profile 104, and/or the interface 106. It is to be appreciated that the distribution component 102, the sharing profile 104, and the interface 106 can be substantially similar to respective components, profiles, and interfaces described in previous figures. The system 500 further includes an intelligent component 502. The intelligent component 502 can be utilized by the distribution component 102 to facilitate communicating data with a mobile device utilizing a sharing profile. For example, the intelligent component 502 can infer publication settings for transmitted data (e.g., layout, format, etc.), security settings, time delay for transmission, an automatic transmission on a schedule, optimized format settings based on target entity (e.g., display, resolution, size, etc.), notification manner (e.g., determining optimized notification technique, etc.), optimal sharing/distributing frequency, proximity transmission settings, and/or any suitable detail related to transmitting data to an entity within a transmission mode.

It is to be understood that the intelligent component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The distribution component 102 can further utilize a presentation component 504 that provides various types of user interfaces to facilitate interaction between a user and any component coupled to the distribution component 102. As depicted, the presentation component 504 is a separate entity that can be utilized with the distribution component 102. However, it is to be appreciated that the presentation component 504 and/or similar view components can be incorporated into the distribution component 102 and/or a stand-alone unit. The presentation component 504 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the distribution component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. In another example, a device may have a pulley button which can allow a user to easily switch from one sharing profile to another. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

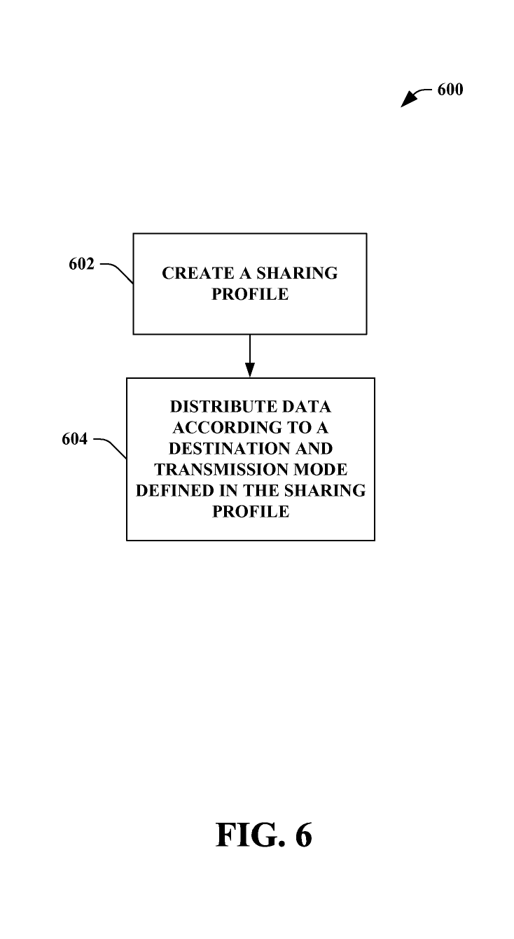

FIGS. 6-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 6 illustrates a method 600 that facilitates employing a sharing profile for data communication with a mobile device. At reference numeral 602, a sharing profile can be created. For example, the sharing profile can be created and stored in connection with a mobile device, wherein the mobile device can be, but is not limited to, a mobile communication device, a cellular device, a text messaging device, a hand-held, a portable digital assistant (PDA), a media player, a laptop, a machine, a smartphone, a device with data sharing capabilities, a device with data transmission characteristics, etc. It is to be appreciated that the sharing profile can define a target entity and a transmission mode. For instance, the sharing profile can define a list of entities (e.g., user, machine, website, online community, device, etc.) and a preferred mode of data communication (e.g., Bluetooth, MMS, home email, work email, infra red, online web space, NFC, text message, instant message, SMS, etc.).

At reference numeral 604, data can be distributed according to the destination (e.g., target entity) and transmission mode defined in the sharing profile. Specifically, a portion of data can be identified, selected, and/or captured by a device, wherein such data can be transmitted based at least in part upon a definition associated with the sharing profile. Thus, the data can be communicated utilizing the sharing profile and respective definitions associated with at least one target entity and a transmission mode. For example, a sharing profile can be created in connection with a smartphone with camera functionality. With the sharing profile active, data captured and/or identified can be automatically transmitted based at least in part upon the sharing profile which defines at least one target entity and a transmission mode. If the sharing profile defines the target entities as Bob and Joe via MMS, the data identified and/or captured will be automatically transmitted to Bob and Joe via MMS with little user intervention or redundant procedures, steps, etc.

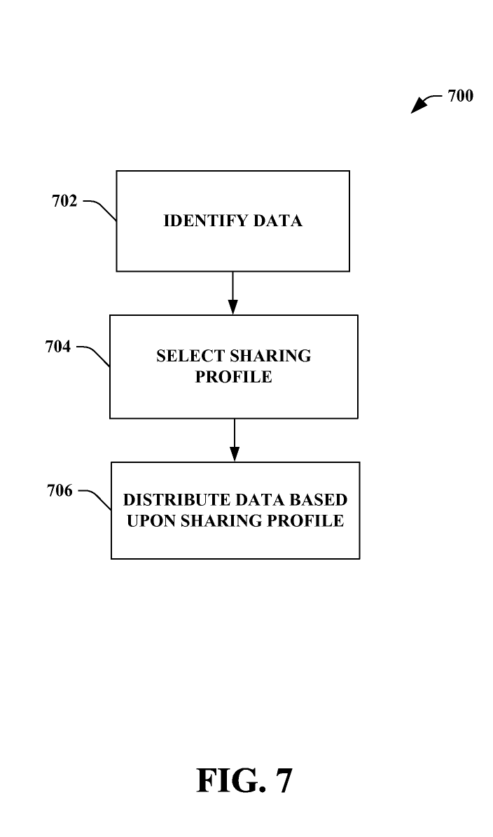

FIG. 7 illustrates a method 700 that facilitates transmitting selected data to a plurality of entities with respective distinct characteristics. At reference numeral 702, data can be identified. It is to be appreciated that data can be identified by at least one of a user selection, a user initiated capture, a device automatic data collection (e.g., camera, image, audio, video, etc.), a device selection, etc. In other words, a portion of data can be identified by at least one of a user, a machine, and/or any suitable combination. At reference numeral 704, a sharing profile can be selected. The sharing profile can define at least one target entity (e.g., target destination) and a transmission mode and/or transmission technique. At reference numeral 706, the identified data can be distributed based at least in part upon the sharing profile and corresponding target entity and transmission mode. In other words, any data identified in relation to reference numeral 702 can be automatically distributed based upon the active sharing profile which defines a target entity and a transmission mode.

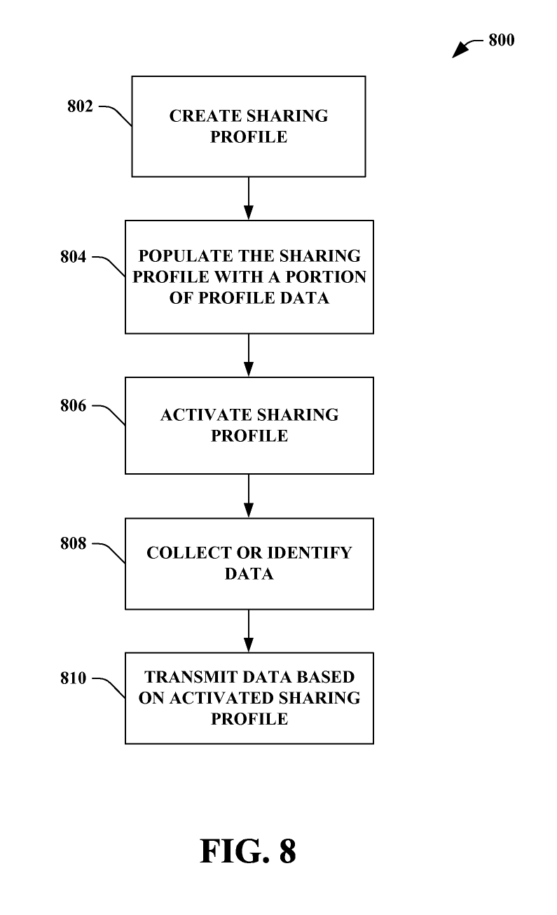

FIG. 8 illustrates a method 800 for communicating data with a mobile device utilizing a sharing profile. At reference numeral 802, a sharing profile can be created. The sharing profile can define at least one target entity and a transmission mode. An entity can be, but is not limited to, a user, a machine, a device, a portable device, a recipient, a web server, an online community, a peer-to-peer network, a network, an online environment, a website, an email server, a laptop, a personal computer, a cellular phone, a mobile communications device, a cellular device, a portable digital assistant (PDA), a hand-held, a smartphone, a portable media device, a gaming device, a blog, an online forum, a data store, a display device, a television, a plasma display, a liquid crystal display (LCD), a monitor, etc. Furthermore, it is to be appreciated that the transmission mode can be most any suitable mode and/or technique (e.g., website, application, environment, etc.) such as, but not limited to, email, multi-media service (MMS), video, text message, audio, image, Bluetooth, wireless, Wi-Fi, Infra Red, posting to an online environment, publication to the Internet, instant message, voicemail, a post to a website, near field communications (NFC), etc.

At reference numeral 804, the sharing profile can be populated with a portion of profile data. For instance, the profile data can be any suitable setting and/or configuration data such as, but not limited to, target entity, (e.g., user, machine, device, website, online environment, online community, etc.), transmission mode (e.g., wireless, MMS, text message, SMS, video, audio, image, etc.), a time delay for transmission (e.g., transmit upon data selection, transmit with time delay upon data selection, etc.), an automatic transmission on a schedule, entity data (e.g., priority, target address, device associated with entity, entity name, entity location, entity preferences, etc.), notification settings (e.g., transmission success receipt, read receipt to target entity, publication notification, notification technique/mode, etc.), transmission settings (e.g., maximum/minimum data transmission limits, time stamp, transmission size, date, etc.), publication configuration (e.g., website location/address, entity address, format, layout, resolution of data, data size, etc.), security (e.g., display of target entities, data protection, etc.), frequency of sharing/distributing data, proximity transmission settings (e.g., distribute according to activated sharing profile within a particular geographic distance, etc.), online versus offline, size of content, personalization information (e.g., background, priority, etc), and/or any suitable detail related to transmitting data to an entity within a transmission mode.

At reference numeral 806, the sharing profile can be activated. It is to be appreciated that the sharing profile can be utilized by any suitable device that can transmit data to at least one entity. Moreover, the sharing profile can be activated and/or utilized by such device. At reference numeral 808, data can be collected and/or identified. For example, the device can capture data and be identified by a user. In another example, the device can automatically collect data without user intervention (e.g., video, etc.). At reference numeral 810, the identified and/or collected data can be transmitted based upon the activated sharing profile. In other words, the data can be transmitted to the target entity via the transmission mode defined by the active sharing profile.

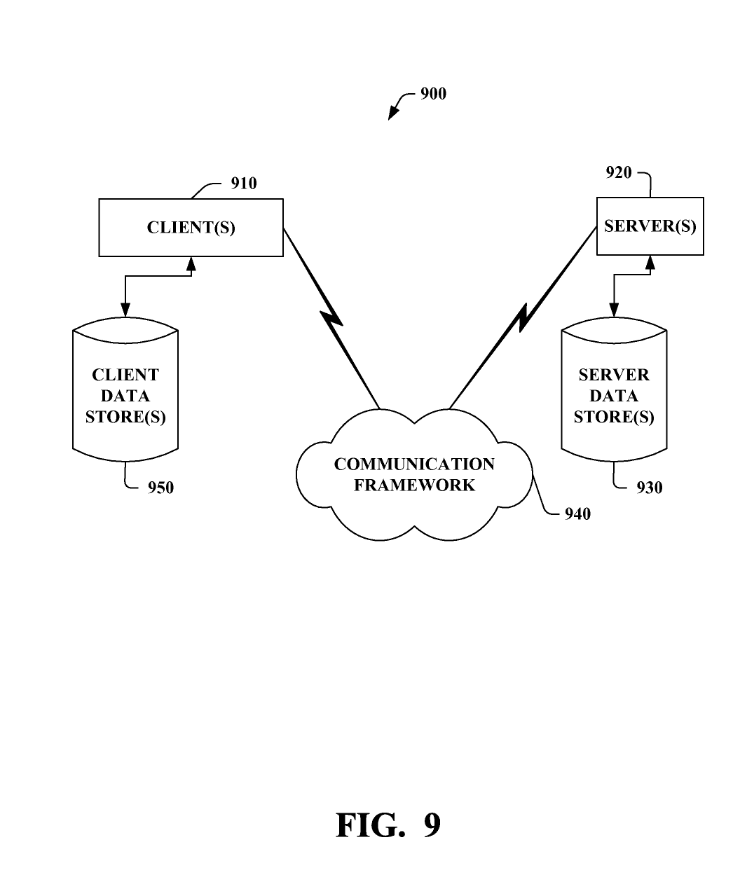

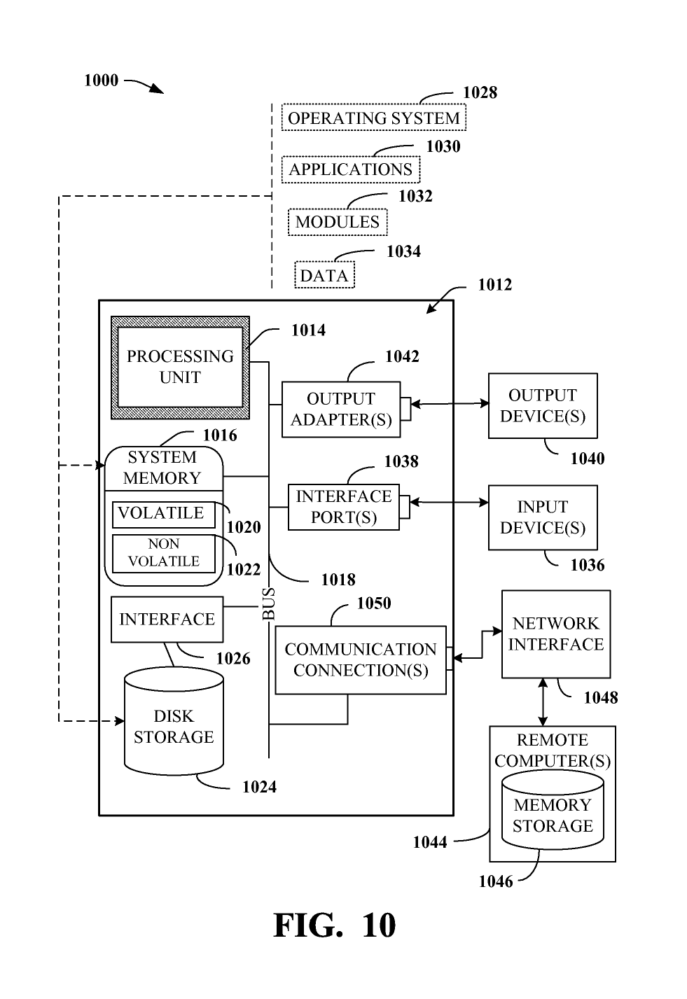

In order to provide additional context for implementing various aspects of the claimed subject matter, FIGS. 9-10 and the following discussion is intended to provide a brief, general description of a suitable computing environment in which the various aspects of the subject innovation may be implemented. For example, a distribution component that transmits a portion of data based upon an active sharing profile defining a target entity and transmission mode, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 950 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates data transmission related to a mobile device, comprising:
an interface component that receives a portion of data associated with a mobile device; and
a distribution component that transmits the portion of data from the mobile device to a target entity based at least in part upon an active sharing profile that defines the target entity and a respective transmission mode.

2. The system of claim 1, the target entity is at least one of a user, a machine, a device, a portable device, a recipient, a web server, an online community, a peer-to-peer network, a network, an online environment, a website, an email server, a laptop, a personal computer, a cellular phone, a mobile communications device, a cellular device, a portable digital assistant (PDA), a hand-held, a smartphone, a portable media device, a gaming device, a blog, an online forum, a data store, a display device, a television, a plasma display, a liquid crystal display (LCD), or a monitor.

3. The system of claim 1, the transmission mode is at least one of an email, a multi-media service (MMS), a portion of video, a text message, a portion of audio, an image, a Bluetooth technique, a wireless mode, a near field communication (NFC), a Wi-Fi mode, Infra Red, a posting to an online environment, a publication to the Internet, an instant message, a voicemail, an instant messaging session, or a post to a website.

4. The system of claim 1, further comprising a settings component that populates and enforces a characteristic with the active sharing profile, the characteristic is defined by a portion of profile data provided by a user.

5. The system of claim 4, the characteristic is at least one of a time delay for transmission to the target entity or an automatic transmission on a schedule.

6. The system of claim 4, the characteristic is a portion of entity data, the entity data is at least one of a priority ranking related to a target entity, an address related to a target entity, a device associated with the target entity, a name related to the target entity, a location associated with the target entity, or a preference related to the target entity.

7. The system of claim 4, the characteristic is a notification to at least one of the target entity or the distribution component.

8. The system of claim 7, the notification indicates at least one of a receipt of data, a completion of transmission, a read receipt, a publication notification, an error notification, or a data communication related to a status of the data transmission.

9. The system of claim 4, the characteristic is at least one of a transmission setting, a maximum data transmission limit, a minimum data transmission limit, a time stamp, a transmission size, or a date.

10. The system of claim 4, the characteristic relates to at least one of a publication configuration, a website location, an entity address, a format for the data transmitted, a layout for the data transmitted, a data resolution for the data transmitted, a data size, a security for the data transmitted, an online status such as online versus offline, a size of content, a personalization of information or a frequency of sharing data.

11. The system of claim 4, the characteristic enables a proximity sharing technique that distributes according to at least one target entity within a particular geographic distance, the distribution occurs with a wireless transmission if within the particular geographic distance.

12. The system of claim 1, further comprising a manager component that manages at least one sharing profile related to the mobile device.

13. The system of claim 12, the manager component employs at least one of an active sharing profile mode, or a passive sharing profile mode.

14. The system of claim 1, the active sharing profile is initiated by a dedicated hardware soft key.

15. The system of claim 1, the mobile device includes a plurality of sharing profiles defined by a user, the active sharing profile is initiated by the user to transmit data.

16. A computer-implemented method that facilitates communicating data associated with a mobile device, comprising:
creating a sharing profile on a mobile device; and
distributing data from the mobile device according to a target entity and a transmission mode defined in the sharing profile.

17. The method of claim 16, further comprising:
identifying data with the mobile device;
capturing data with the mobile device;
collecting data with the mobile device;
selecting the sharing profile with the mobile device; and
transmitting data based upon the sharing profile mode.

18. The method of claim 16, further comprising:
transmitting data to at least one target entity based on a geographic proximity; and
employing a time delay to the data transmission.

19. The method of claim 16, further comprising:
populating the sharing profile with a portion of profile data;
activating the sharing profile;
automatically uploading identified data; and
automatically transmitting data based upon such identification.

20. A computer-implemented system that facilitates data transmission related to a mobile device, comprising:
means for receiving a portion of data associated with a mobile device;
means for creating a sharing profile that defined a target entity and a transmission mode;
means for activated a sharing profile on a mobile device; and
means for transmitting the portion of data to the target entity via the transmission mode based at least in part upon the activated sharing profile.
